(19) United States
(12) Patent Application Publication
(10) Pub. No.: US 2025/0126068 A1
(43) Pub. Date: Apr. 17, 2025

(54) DYNAMIC RATE LIMITER TO CONTROL SERVER ACCESS

(71) Applicant: Lookout, Inc., Boston, MA (US)

(72) Inventors: Kumar Srikrishna Surendra Chitta, Hyderabad (IN); Anil Kumar Kotha, Ponnur (IN); Nitesh Kumar, Hyderabad (IN); Sharat Gowtam Peri, Hyderabad (IN)

(21) Appl. No.: 18/488,890

(22) Filed: Oct. 17, 2023

(51) Int. Cl. H04L 47/20; H04L 41/16; H04L 43/065

(52) U.S. Cl. CPC H04L 47/20; H04L 41/16; H04L 43/065

(57) ABSTRACT

Systems, methods, and apparatus related to server access. In one approach, a computing device accesses one or more external servers through a gateway. A rate at which the computing device accesses the servers is controlled based on monitoring the context of a computing environment. Examples of the context include available spare processing bandwidth and/or processing rates for a given user or tenant. The rate is regulated by a dynamic rate limiter and is updated in real-time to reflect any changes to the monitored context.

### FIELD OF THE TECHNOLOGY

At least some embodiments disclosed herein relate to network communications in general, and more particularly, but not limited to controlling a rate of access by client devices to servers and/or other network devices.

### BACKGROUND

In a client/server architecture, a server can sometimes become overloaded with incoming requests. For example, the server may be subject to a denial of service attack. Static rate limiting mechanisms are sometimes implemented on the server side (e.g., a server rejects any requests arriving at over a threshold rate). For example, this is sometimes implemented in load balancers.

In one example, when implementing services that process requests or messages in a micro services architecture implementation, or an event driven architecture implementation, static rate limiting can help minimize failures. This is because request/message processing services typically depend on internal/external application services and infrastructure services for processing requests/messages. For example, the processing throughput of the processing services will depend on the health and rate limits of the dependent application services/infrastructure services.

In some cases, static rate limiting is also implemented on the client side. There are various static rate limiting products such as from Google, etc. For example, it is a common practice for servers to enforce API static rate limiting to regulate the usage of API-based services that are exposed. In such scenarios, rate limiting can also be enforced by client side services, so that consumers of the API services can be assured that the service provider will successfully process the requests without rejecting them. In the absence of rate limiting on the client side, consumers of the API services may face sudden or unexpected rejection of their requests, impacting their workflow. This may be avoided if the client side services have rate limiting enforced when calling the APIs of a service provider.

### BRIEF DESCRIPTION OF THE DRAWINGS

The embodiments are illustrated by way of example and not limitation in the figures of the accompanying drawings in which like references indicate similar elements.

FIG. 1 shows a rate limiter that controls access by services to various remote computing devices, in accordance with some embodiments.

FIG. 2 shows a rate limiter that controls a rate of access by services to remote computing devices based on monitoring a context of one or more computing environments, in accordance with some embodiments.

FIG. 3 shows a gateway that gathers metadata from various computing devices for use in controlling rates of remote server access, in accordance with some embodiments.

FIG. 4 shows one or more services that are controlled by a rate limiter when processing messages provided by a message broker from a message queue, in accordance with some embodiments.

FIGS. 5A and 5B show a rate limiter that controls rate limits for application services based on monitoring of health and performance metrics, in accordance with some embodiments.

FIG. 6 shows a rate limiter that controls rate limits for access to remote servers by event processors based on output from a metrics analyzer, in accordance with some embodiments.

FIG. 7 shows a rate limiter that controls rate limits for regular events and overflow events based on monitoring metrics, in accordance with some embodiments.

FIG. 8 shows a method for dynamically updating rate(s) at which application service(s) are permitted to access one or more servers, in accordance with some embodiments.

FIG. 9 shows a block diagram of a computing device (e.g., an application services server, a computing device running a hypervisor, a gateway, a network device, a monitoring server, or mobile device management (MDM) server) which can be used in various embodiments.

FIG. 10 shows a block diagram of a computing device (e.g., an endpoint device, a mobile device of a user, or a user terminal), according to one embodiment.

### DETAILED DESCRIPTION

The following disclosure describes various embodiments for controlling a rate of access by client devices to servers and/or other network devices. At least some embodiments herein relate to rate limiting handled by a dynamic rate limiter for application services that process requests and/or messages in a micro services architecture or an event driven architecture. This dynamic rate limiting helps minimize processing failures and/or enhance tenant fairness when processing requests and/or messages.

In contrast to dynamic rate limiting as described herein, existing static rate limiters (e.g., rate limiters offered by Redis or Google) use pre-configured static rate limits. Static rate limiters typically use a token bucket implementation and require manual intervention to modify the rate limits.

Such static rate limiters cannot dynamically respond to temporary outages or degradation of dependent service(s) or infrastructure. In one example, API rate limits of third party services (e.g., API gateways of SaaS clouds) are not static, but vary dynamically depending on peak load or any other service outage. Often, error responses are received even when pre-defined server side API rate limits are not breached. There can be many such unforeseen issues with dependent application services or infrastructure services resulting in a temporary outage of these services.

In the case of a temporary outage of an API server or another dependent application or infrastructure service, request and/or message processing continues at a pre-configured static rate. This can bleed processing bandwidth and cause irrecoverable failures, resulting in a higher failure rate. In such scenarios, services typically have a fail retry mechanism, where the requests or messages are re-processed a fixed number of times and then dropped. So, there is a significant risk that a large number of requests or messages may be permanently dropped during a temporary outage of the server or service.

Instead of using such static rate limiters, dynamic rate limiting as described herein is used. For example, in the case of a temporary outage (e.g., a 429 error response) (e.g., a cloud server is processing too many requests) and/or a dependent service is unavailable, a request/message processing service is controlled to slow down or stop the processing of more requests/messages (e.g., slowed for a time period). This is done instead of retrying, failing, and dropping the requests/messages as with prior static rate limiters. For example, a dynamically-controlled application service can revert back to its steady-state processing rate once the health of the dependent service(s) is restored.

The use of a dynamic rate limiter can also address other problems. In one example, dynamically adjusting rate limits (e.g., per tenant/account/user) enhances tenant/account/user fairness (e.g., fair allocation of resources) when processing requests in a computing environment with limited processing bandwidth. Also, any spare processing bandwidth can be better shared at the tenant/account/user level, with the ability to dynamically adjust rate limits (e.g., based on peak versus off-peak hours).

Regarding client rate limiting, even if a server itself is doing rate limiting, there is a benefit to rate limiting at a client. This helps avoid the client device from hitting the server with more requests than is desirable. However, using only a static rate limiter on the client side that is accessing a server can cause problems. The server provider typically specifies a limit on API accesses per minute. The client rate limiting is done to attempt to stay within this limit. If the client exceeds the limit, the server rejects new requests due to overload. In such case, the client device has difficulty recovering from such failure. If many requests are sent to the server, then there can be many failed requests. The client will not be able to process all these failures, and some will be dropped permanently.

To address the above problems of static rate limiters and other technical problems, at least some embodiments provide a dynamic rate limiter to control rate limits for application services. In one embodiment, the application services are dependent on one or more internal application services, external application services, and/or infrastructure services for processing events, requests, and/or messages. The dynamic rate limiter is configured to continuously analyze various metrics. In one example, the service health metrics and/or application performance metrics of various dependent application and/or infrastructure services are analyzed. In one example, the analysis is done at a tenant, account, and/or user level.

Based on this analysis, the dynamic rate limiter regularly updates the rate limits of the application services. In one example, the rate limits are updated at least once every 10 seconds or less (or some other periodic time interval). In one example, the rate limits are updated at a tenant/account/user level at runtime, to reflect the health and processing capability of the dependent application and/or infrastructure services.

In one embodiment, a system includes a gateway (e.g., cloud API gateway) configured to provide network access to at least one server (e.g., external cloud servers). One or more computing devices are configured to execute at least one service (e.g., an application service) that accesses the server via the gateway.

At least one computing device controls at least one rate at which the service accesses the server (e.g., using a dynamic rate limiter process coupled to a static rate limiter instance for a tenant or user). At least one computing device monitors a context associated with the service, and dynamically updates the rate at which the service accesses the server to reflect any changes to the monitored context. In one example, the updates are made in real-time such as, for example, less than 1-3 seconds after a change in context is determined by a server running a process to monitor network status codes and/or other health or performance metrics.

In one embodiment, one or more external servers (e.g., in a data center) and/or clouds (e.g., public or private) are accessed by one or more application services. The application services execute on one or more computing devices of a computing environment (e.g., an internal network of an enterprise customer, or a server of a cloud access security broker). The application services access the server(s) through at least one gateway (e.g., a gateway connecting an internal network to external servers of a public cloud).

A dynamic rate limiter controls at least one rate at which the application services access the server(s). The dynamic rate limiter receives monitoring data regarding at least one network or computing device (e.g., health or performance metrics for internal and/or external networks or servers). The dynamic rate limiter evaluates the monitoring data, and then dynamically updates the at least one rate at which the application services access the server based on the evaluation.

In one embodiment, the dynamic rate limiter is a dynamic rate process (e.g., running on one or more microprocessors and/or running in one or more virtual machines supported by a hypervisor in a cloud) used to reset the respective rate limit for one or more instances of a static rate limiter. The reset rate limits reflect changes in a computing environment(s) context determined from metrics monitoring.

In various embodiments, the dynamic rate limiter is capable of taking data feeds from one or more monitoring services and processing multiple inputs. These inputs can include one or more of the following:

Service health metrics of application and/or infrastructure services
Application performance metrics
API error metrics
Service integration errors of application and/or infrastructure services
Event arrival rates per tenant/account/user
Real-time event processing rates per tenant/account/user
Event processing rates of upstream and/or downstream services

The dynamic rate limiter continuously re-calculates desired (e.g., optimal) processing rates (e.g., per tenant/account/user) based on the above inputs. In one example, the desired rates are reconciled with any predefined static rate limits.

In one embodiment, the dynamic rate limiter calculates desired (e.g., optimal) processing rates based on one or more machine learning models. The models are trained based on historical data analysis (e.g., data including the inputs above). In one example, the machine learning model is an artificial neural network.

In one embodiment, the dynamic rate limiter integrates with an existing static rate limiter(s) to dynamically reset the processing rate limits per tenant/account/user on a real-time basis. Existing services can integrate with static rate limiters and respond to the changes in rate limits controlled by the dynamic rate limiter. Thus, for example, integration of the dynamic rate limiter can be transparent to existing implementations that integrate with static rate limiters.

In one example, the above integration of existing services with a dynamic rate limiter can minimize processing failures. Using the dynamic rate limiter, fewer or no requests are expected to fail to be processed because of a temporary outage of any dependent service and/or system. Other benefits can include enhanced tenant/account/user fairness (e.g., in bandwidth or resource allocation) when processing events, and more optimal sharing of spare processing bandwidth for faster processing of backlog events.

In one embodiment, an application service that is dependent on one or more external services (e.g., a cloud API gateway, Redis, etc.) is controlled by the dynamic rate limiter. For example, a rate of requests made by the application service to an API is controlled by the dynamic rate limiter.

In one embodiment, a request and/or message processing rate of an application service is controlled by rate limits imposed by a static rate limiter. In one example, the static rate limiter is a token bucket algorithm implementation.

A dynamic rate limiter is coupled to the static rate limiter. The dynamic rate limiter continuously adjusts and/or resets the static rate limits enforced by the static rate limiter. This adjustment and/or resetting is based on feedback received from monitoring of metrics. The metrics generally relate to a context of one or more computing environments (e.g., a processing load due to security risk assessment of user or tenant devices).

In one embodiment, the monitoring is used to detect one or more temporary outages of dependent services. Examples of metrics monitored can include one or more of the following:
429 (too many requests) errors of a cloud API gateway
503 (service unavailable) errors of a cloud API gateway
502 (API gateway-upstream service errors).
Dependent services health check errors

Until the temporary outage(s) is resolved, rate limits are reduced or reset to zero or another value (e.g., a lower rate limit than a default limit used in normal operation). Once the outage(s) is resolved (e.g., when dependent services are up and running in a healthy mode), the application service resumes processing at the default limit (or other limit greater than zero). For example, rate limits are restored by the dynamic rate limiter once the monitored dependent services recover from the outage(s). This, for example, helps ensure that events and/or messages are not dropped after exhausting maximum fail/retry attempts, which occurs during the temporary outage(s).

Several advantages are provided by various embodiments of the dynamic rate limiter described herein. In one advantage, processing failures are reduced. A dynamic rate limiter can assess the nature of failure(s) at runtime and adjust rate limits dynamically to ensure that request/message processing failures are reduced (e.g., minimized to zero in a best case). The dynamic rate limiter adjusts the processing rate of the requests/messages to reflect the processing capability and health of the dependent application service(s) and/or infrastructure services. This helps to ensure that no messages are dropped during a temporary outage and the messages are processed successfully once the health of the dependent or other services is restored.

In one advantage, enhanced tenant/account/user fairness is achieved when processing events in environments with limited processing capacity. This is made possible by feeding the dynamic rate limiter with data of real-time event arrival rate/processing throughput per tenant/account/user and adjusting rate limits per each tenant/account/user dynamically. The processing rate of requests/messages for a tenant/user/account can be adjusted dynamically based on various factors like the licensing norms applicable and/or spare capacity available for processing requests/messages per tenant/account/user. This ensures enhanced fairness in processing requests/messages at more optimal processing rates for any given tenant/account/user. Tenant fairness can be implemented to offset negative effects of any infrastructure limitations.

In one advantage, utilization of spare processing bandwidth is improved. When processing real time events (e.g., as per a service-level agreement (SLA) commitment), it is common to have backlog queue(s) that will be filled with overflow events that are processed separately. Overflow events are, for example, the events arriving over and above a pre-configured threshold arrival rate per tenant/account/user. Such overflow events are processed separately at a lower processing rate, to ensure that achieving the SLA commitment for the events arriving below the pre-configured arrival rates is not impacted.

A dynamic rate limiter is capable of monitoring the processing rate of events for a specific tenant/account/user to dynamically adjust the processing rate of overflow events to take advantage of the spare bandwidth available for processing events of the respective tenant/account/user (especially during off-peak hours). This ensures more desirable utilization of the spare capacity available at a tenant/account/user level, and reduced or minimal impact to an SLA commitment for overflow events in the backlog queues.

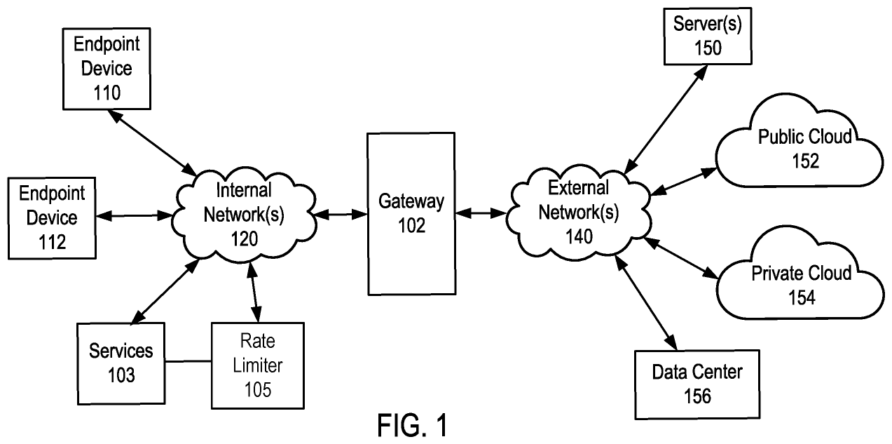

FIG. 1 shows a rate limiter 105 that controls access by services to various remote computing devices, in accordance with some embodiments. Endpoint devices 110, 112 and computing devices providing services 103 communicate with various remote computing devices through a gateway 102. In one example, services 103 includes application services as described above. In one embodiment, a rate of access by services 103 to server 150 and/or other remote computing devices is controlled by rate limiter 105. In one example, rate limiter 105 is a dynamic rate limiter as described above. In one example, a rate limit controls a number of API requests made by a service 103 to server 150.

In one example, the remote computing devices include server 150, public cloud 152, private cloud 154, and/or data center 156. The remote computing devices generally include any computing device that communicates over a network. For example, in some cases, the remote computing devices provide external services to the endpoint devices, and/or provide external services to internal services 103. In one example, the services include software as a service and/or infrastructure as a service.

The endpoint devices and services 103 communicate with gateway 102 through one or more internal networks 120. For example, internal networks 120 can include wireless networks, local area networks, secure tunnels, and/or wide area networks.

Gateway 102 acts as a gateway for communications between the endpoint devices 110, 112, and/or services 103, and the remote computing devices. By acting as a gateway, gateway 102 can perform security risk or other performance metrics evaluation and/or control communications by any given device with the remote computing devices and/or any other computing devices (e.g., network devices associated with internal network 120). In one embodiment, gateway 102 controls communications and/or other functions of each endpoint device using an endpoint agent installed on the endpoint device.

The endpoint devices and services 103 communicate through gateway 102 with the remote computing devices using one or more external networks 140. For example, external networks 140 can include wireless networks, local area networks, secure tunnels, and/or wide area networks.

In one embodiment, rate limiter 105 is used to control rates of access by endpoint devices 110, 112 to servers 150.

In one example, gateway 102 is implemented in a cloud computing environment (e.g., Amazon Web Services (AWS) or Microsoft Azure) on one or more virtual machines. In one example, gateway 102 is implemented on a computing device in the same premises as one or more of the endpoint devices and/or network devices associated with internal networks 120.

In one example, a computing environment operates in conjunction with embodiments of services 103, rate limiter 105, and/or gateway 102. The components of the computing environment may be implemented using any desired combination of hardware and software components.

An exemplary computing environment may include endpoint devices and/or other devices providing internal services, with each device configured as a client computing device. The computing environment may also include a provider server, an authentication server, and/or a cloud component, which communicate with each other over a network (e.g., network 120).

The client computing device may be any computing device such as desktop computers, laptop computers, tablets, PDAs, smart phones, mobile phones, smart appliances, wearable devices, IoT devices, in-vehicle devices, and so on. In one example, the client computing device accesses services at the provider server (e.g., server 150).

The client computing device (e.g., endpoint device 110) may include one or more input devices or interfaces for a user of the client computing device. For example, the one or more input devices or interfaces may include one or more of: a keyboard, a mouse, a trackpad, a trackball, a stylus, a touch screen, a hardware button of the client computing device, and the like. The client computing device may be configured to execute various applications (e.g., a web browser application or mobile app) to access other devices on the network.

The provider server (e.g., server 150, and/or servers providing services 103) may be any computing device configured to host one or more applications/services. In some embodiments, the provider server may require security verifications before granting access to the services and/or resources provided thereon. In some embodiments, the applications/services may include online services that may be engaged once a device has authenticated its access. In some embodiments, the provider server may be configured with an authentication server for authenticating users and/or devices. In other embodiments, an authentication server may be configured remotely and/or independently from the provider server.

In one example, the network may be any type of network configured to provide communication between components of a cloud system. For example, the network may be any type of network (including infrastructure) that provides communications, exchanges information, and/or facilitates the exchange of information, such as the Internet, a Local Area Network, Wide Area Network, Personal Area Network, cellular network, near field communication (NFC), optical code scanner, or other suitable connection(s) that enables the sending and receiving of information between the components of the cloud system. In other embodiments, one or more components of the cloud system may communicate directly through a dedicated communication link(s).

In various examples, the cloud system may also include one or more cloud components. The cloud components may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.). In some examples, either one or both of the provider server and the authentication server may be configured to operate in or with cloud computing/architecture such as: infrastructure a service (IaaS), platform as a service (PaaS), and/or software as a service (SaaS).

In one example, the endpoint devices and/or other nodes of networks 120, 140 can each be a part of a peer-to-peer network, a client-server network, a cloud computing environment, or the like. Servers providing services 103 and/or gateway 102 can operate as a server(s) in a client-server network environment, as a peer machine in a peer-to-peer (or distributed) network environment, and/or as a server or a client machine in a cloud computing infrastructure or environment.

In one embodiment, gateway 102 evaluates potential security risks based on data gathered from various sources. From this evaluation, gateway 102 can identify one or more security risks. For example, the gathered data can include metadata gathered from the endpoint devices. The gathered data also can include metadata gathered from networks 120. For example, gateway 102 can collect metadata from network devices (not shown) of network 120. The gathered metadata can be used as part of metrics that are monitored by rate limiter 105.

In some cases, metadata can also be collected from external network 140 and/or remote computing devices. For example, an application programming interface (API) of server 150 or public cloud 152 can be a source of data used for security risk evaluation.

In one example, if a program running on an endpoint device is intending or attempting to exfiltrate data from the endpoint device, either a software component running locally on the endpoint device can pretend to be the intended destination host exfiltration point, and can capture the data which is being sent by that program for further analysis (e.g., the further analysis can be performed by gateway 102). In this example, the data is not actually being sent to any real exfiltration point, but rather is being recorded for further analysis by an automated process or a human. The captured data can be included in metrics monitored by rate limiter 105.

In one embodiment, gateway 102 determines characteristics associated with an endpoint device and/or services 103. These characteristics are communicated to gateway 102 as metadata. This metadata can be part of monitored metrics by rate limiter 105.

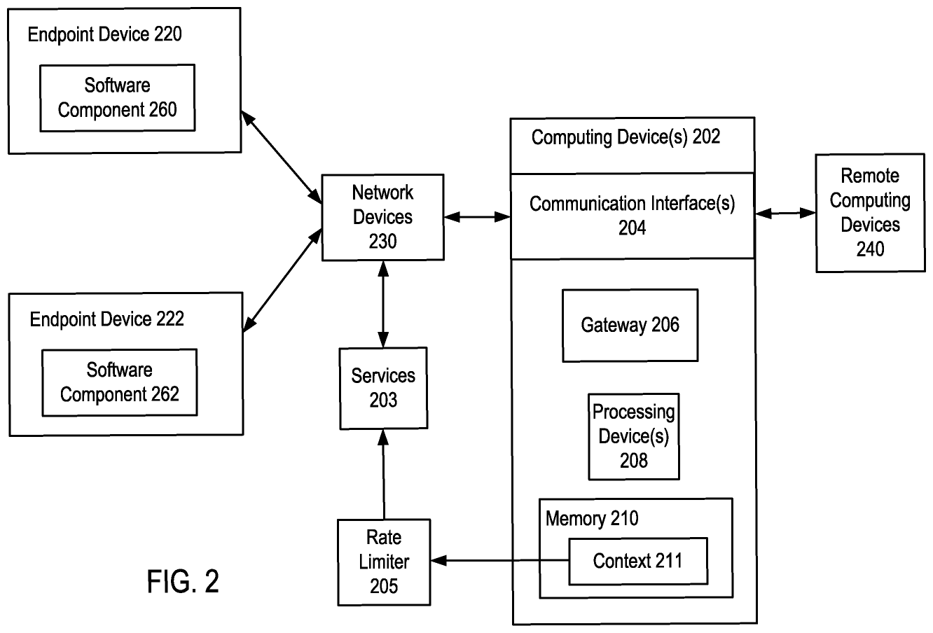

FIG. 2 shows a rate limiter 205 that controls a rate of access by services 203 to remote computing devices 240 based on monitoring a context 211 of one or more computing environments (e.g., server loads or processing rates), in accordance with some embodiments. Services 203 communicate with remote computing devices 240 using gateway 206.

In one embodiment, gateway 206 evaluates security risks associated with processes running on endpoint devices 220, 222. Gateway 206 is an example of gateway 102. Endpoint devices 220, 222 are an example of endpoint devices 110, 112.

In one embodiment, endpoint agents (not shown) are installed on endpoint devices 220, 222 and collect data from the respective endpoint devices. The collected data is then gathered by gateway 206 as metadata. The endpoint agents are, for example, software applications that have been downloaded by a user onto endpoint devices 220, 222 (e.g., downloaded from a mobile app store).

Software component 260 (e.g., a security or health monitoring application) is installed on endpoint device 220. Software component 262 is installed on endpoint device 222. In one example, software components 260, 262 are applications or other programs downloaded from an application store or other source and installed by a user.

In one example, remote computing devices 240 include server 150, public cloud 152, private cloud 154, and/or data center 156.

In one embodiment, endpoint agents installed on endpoint devices collect metadata that indicates characteristics associated with network communications. Endpoint agents communicate with gateway 206 through one or more network devices 230. In one example, network devices 230 are configured as part of internal networks 120. In one example, network devices 230 include routers, switches, firewall devices, and/or security appliances.

In one embodiment, a software component is installed on each of network devices 230, and each software component communicates with gateway 206 to provide metadata related to network communication occurring on the respective network device. The metadata from the network devices 230 is used by gateway 206 in combination with metadata from endpoint agents to identify security risks and/or monitor context 211.

Various computing device(s) (not shown) are part of and/or coupled to network devices 230 and are used to provide services 203. Services 203 is an example of services 103. Services 203 make access requests (e.g., API calls) to remote computing devices 240. Rate limiter 205 controls a rate of these access requests based on evaluation of context 211. In one example, services 203 provide security risk monitoring and remediation services (e.g., monitoring of risk for endpoint devices 220, 222 and/or network devices 230).

In one embodiment, gateway 206 gathers data associated with characteristics of network communications occurring through the gateway 206 with remote creating devices 240. The data associated with these characteristics is used in combination with metadata from endpoint agents, metadata from network devices 230, and/or monitoring data associated with computing resources providing services 203 to evaluate security risks and/or monitor context 211.

In one example, gateway 206 can determine a security risk (e.g., for an endpoint device and/or network device) and take responsive actions similarly as described in U.S. Patent Application Publication US 2020/0304503, published Sep. 24, 2020, by Zerrad et al., and titled “COMMUNICATING WITH CLIENT DEVICE TO DETERMINE SECURITY RISK IN ALLOWING ACCESS TO DATA OF A SERVICE PROVIDER”, which is hereby incorporated by reference in its entirety.

Gateway 206 runs on one or more computing devices 202. One or more communication interfaces 204 of computing devices 202 are connected to network devices 230 for receiving communications from, and sending communications to, endpoint agents. In one example, communication interface 204 is a network interface card. In one example, network device 230 is a router connected to multiple Ethernet networks. Communication interface(s) are also connected for network communications with remote computing devices 240.

Computing device(s) 202 includes one or more processing devices 208 and memory 210. In one example, gateway 206 runs on processing device 208. In one example, a hypervisor runs on processing device 208. The hypervisor manages virtual machines used to implement gateway 206 and/or provide services 203.

Memory 210 is volatile and/or nonvolatile memory used by gateway 206 during execution, including evaluation of metadata for identifying security risks and/or analysis of monitoring metrics for rate control. Data regarding a context 211 of computing environment(s) is stored in memory 210. In one example, context 211 includes collected health and performance metrics. In one example, context 211 includes gathered metadata (e.g., from endpoint agents).

In one example, a machine learning model is stored in memory 210. Metadata or other data regarding context 211 gathered by gateway 206 is an input to the machine learning model. In one example, the machine learning model is an artificial neural network. An output from the machine learning model is used by gateway 206 as part of identifying security risks and/or analysis of data regarding context 211.

In one embodiment, endpoint agents can be implemented in various ways using software and/or hardware. Agents installed on network devices to collect the above metadata for sending to gateway 206 can be implemented similarly.

In one embodiment, once it is confirmed with a threshold level of certainty that an exfiltration event from an endpoint device or network device is occurring, a remediation engine running on computing device(s) 202 proactively takes action to block other commonly-attacked ports between endpoint and/or network devices on the same subnet and other subnets (e.g., same or related RPC port range, SMB).

In one example, a responsive action is to completely block all outbound internet activity. In one example, a responsive action is to kill the individual process (or uninstall the application). In one example, a responsive action is to allow legitimate components or parts of malicious applications continue to run while only blocking access by the malicious applications to undesirable (e.g., bad) domains.

In one embodiment, in response to identifying a security risk, gateway 206 takes actions that include leveraging Security Orchestration Automation & Response (SOAR) type activity combined with remediation action taken at one or more endpoint devices. In one embodiment, these actions can further include actions taken at the firmware or hardware level of an endpoint or network device.

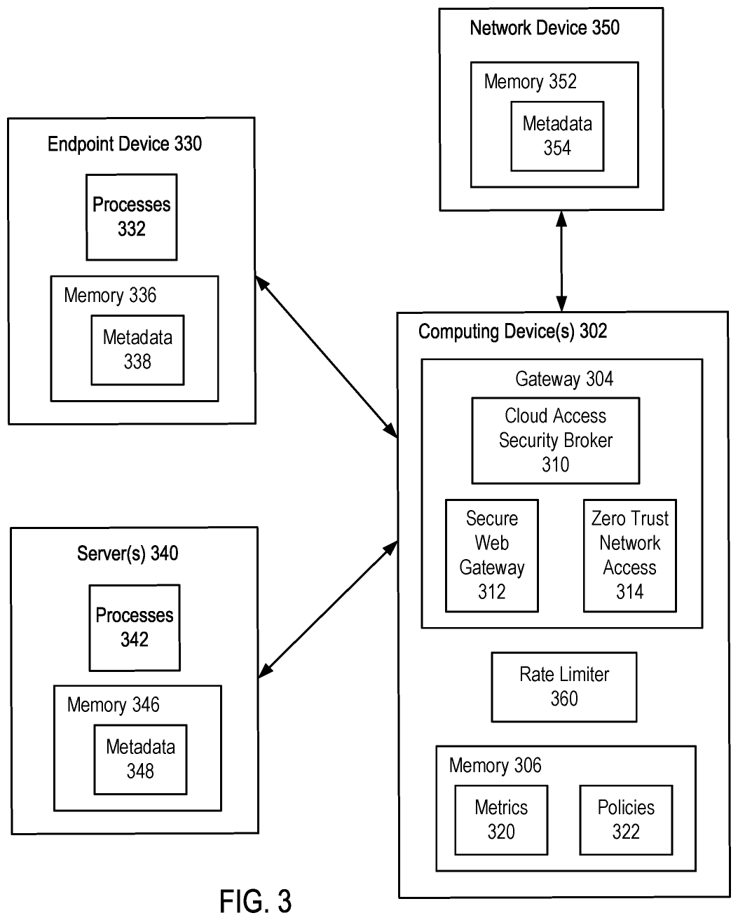

FIG. 3 shows a gateway 304 that gathers metadata (e.g., 338, 348, 354) from various computing devices for use in controlling rates of remote server access, in accordance with some embodiments. In one embodiment, gateway 304 gathers metadata from endpoint agents and/or network devices (e.g., 350) that is used to identify security risks and/or monitor context for controlling a rate of remote server access using rate limiter 360. Rate limiter 360 is an example of rate limiter 105, 205.

Rate limiter 360 uses metrics 320 stored in memory 306. In one example, metrics 320 includes health and/or performance data from monitoring of servers 340 and/or endpoint device(s) 330. Metrics 320 is an example of context 211.

Endpoint device(s) 330 and server(s) 340 communicate with one or more computing devices 302 over a network (e.g., 120). Endpoint device 330 is an example of endpoint devices 110, 112. Network device 350 is an example of network device 230. Server 340 is an example of a server (e.g., a virtual machine running in a cloud computing environment) or other computing device providing services 103, 203. Gateway 304 is an example of gateway 102, 206.

Endpoint device 330 collects metadata 338 and stores it in memory 336. Metadata 338 relates to characteristics of processes 332 running on endpoint device 330. An endpoint agent of endpoint device 330 communicates metadata 338 to gateway 304 (e.g., similarly as described above). Metadata 338 can be included in metrics 320.

Server(s) 340 collects metadata 348 and stores it in memory 346. Metadata 348 relates to characteristics of processes 342 running on server(s) 340. An agent installed on each server 340 communicates metadata 348 to gateway 304. Metadata 348 can be included in metrics 320.

In one embodiment, endpoint or other agents on endpoint devices, servers, and/or network devices communicate metadata to gateway 304 on a periodic basis. In one embodiment, each agent communicates metadata when requested by gateway 304. In one example, gateway 304 makes a request for metadata after identifying a security risk and/or evaluating monitoring metrics. In one example, the request is for metadata specifically related to a process identified as related to the security risk and/or monitored metrics.

In one embodiment, gateway 304 identifies one of processes 332 as a security risk and/or being associated with monitored metrics. In one example, gateway 304 determines that one of processes 342 is the same or similar to the one of processes 332 identified as a security risk. In response to determining that one of processes 342 is also a security risk, gateway 304 sends a request to an agent that requests metadata 348 specifically for the process 342 associated with this identified security risk.

In one embodiment, a software agent on network device 350 collects metadata 354 and stores it in memory 352. The agent sends metadata 354 to gateway 304, either periodically and/or on request (e.g., for a requested particular process) as described above.

Gateway 304 runs on one or more computing devices 302. In one embodiment, gateway 304 runs on one or more virtual machines in a cloud computing environment.

In one embodiment, metadata 320 is stored in memory 306 of computing device 302. Metadata 320 includes metadata collected from endpoint agents, servers 340, and/or network device 350.

In one embodiment, policies 322 are stored in memory 306. Policies 322 include, for example, mobile device management policies for endpoint devices 330, security policies for network device(s) 350, and/or security policies for server(s) 340. In one embodiment, dynamic rate limit control and/or responsive actions taken by gateway 304 (e.g., by rate limiter 360) are configured based on the one or more of policies 322 (e.g., that apply to an endpoint device and/or network device that is to be remediated in some manner).

In one embodiment, gateway 304 implements one or more of cloud access security broker 310, secure web gateway 312, or zero trust network access 314. For example, one or more of the foregoing is implemented for network communication by endpoint devices 330 and/or server(s) 340 with remote computing devices (e.g., 240).

In one example, a large quantity of data is downloaded at a particular endpoint device. Gateway 304 detects this download (e.g., a quantity threshold is exceeded) based on metadata sent from an endpoint agent on the endpoint device. Gateway 304 determines that this is sensitive data, and/or this data is not authorized to be downloaded in bulk. In response, gateway 304 starts incorporating rescue controls. For example, the location of the endpoint device is turned off using a CASB API. For example, an alert is sent by electronic communication (e.g., email or text message) to a network administrator indicating that there is a data exfiltration attempt at this endpoint device. For example, gateway 304 causes automatic quarantining of the endpoint device.

In one example, a malware file is downloaded by an endpoint device. The gateway detects the malware file after it has been downloaded. In one example, the malware files detected using signature analysis, sandboxing, etc. once the gateway determines that the downloaded file is malware, the gateway is able to determine in real-time the identity of computing devices that have the same or similar malware (e.g., using metadata 320). The gateway takes one or more actions to prevent any further damage by the malware (e.g., one or more responsive actions as described above). In one embodiment, the gateway performs monitoring of metrics 320 and/or rate control by rate limiter 360 as a responsive action to detecting malware.

In one example, gateway 304 prevents a cyber attack by using a UEBA engine and/or a DLP policy engine. As soon as the gateway (having UEBA and/or DLP capabilities) observes that a particular user is having an unusual access to a program and/or accessing large quantities of vulnerability reports, the gateway sends signals in real-time to quarantine that user's particular endpoint device.

In one embodiment, gateway 304 is configured as an SSE remediation engine. Various endpoint devices communicate through gateway 302 with various remote computing devices. Endpoint devices include, for example, managed endpoints, user devices in a branch office, and unmanaged endpoints. Remote computing devices include, for example, Internet servers, software as a service cloud, infrastructure as a service cloud, and data center servers.

In one embodiment, each endpoint device has an endpoint agent. Each endpoint agent is capable of blocking connections on its respective endpoint device. In one example, each endpoint agent is able to detect process maps. Data from these process maps can be sent to gateway 304 as metadata. Each endpoint or other agent is able to enforce security at the process level, such as blocking an entire process.

In one example, each endpoint or other agent gathers metadata such as process information, process hierarchy, network elements, process to network handles (e.g., TCP sockets), and communications that are happening. Also, the endpoint or other agent can determine the actual user behind a process or session (e.g., is it a user level process or a system-level process), which can be communicated as metadata to gateway 304.

In one example, gateway 304 gathers metadata such as device source IP, user name, general endpoint device posture (e.g., whether the firewall is running), user risk, user group associations, destination IP, destination port, fully qualified domain names, and/or destination category.

In one embodiment, gateway 304 generally knows about users, devices, applications, source and destination locations, and data being communicated on a network(s). Data regarding these items is tracked in real-time by gateway 304. This data is evaluated to identify security risks and/or monitor context for rate limit control.

In one embodiment, gateway 304 can cause actions to trigger management software that performs uninstallations of types of software believed to be malicious in behavior. In one example, third party applications that have been implanted with malware (e.g., that are signed with legitimate certificates) can be addressed by the foregoing.

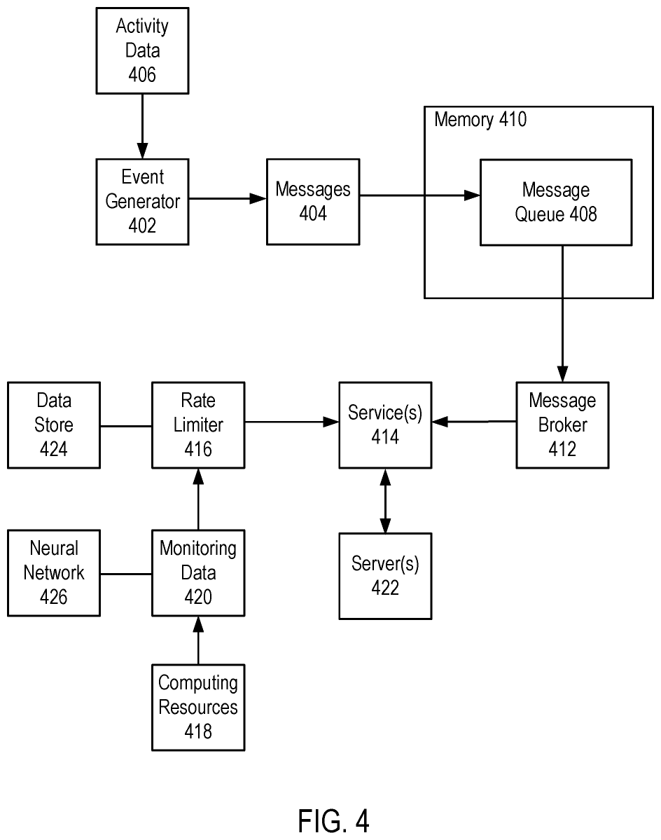

FIG. 4 shows one or more services 414 that are controlled by a rate limiter 416 when processing messages 404 provided by a message broker 412 from a message queue 408, in accordance with some embodiments. Services 414 are executed on one or more computing devices (e.g., servers 340). Services 414 are an example of services 103, 203.

Event generator 402 receives activity data 406. In one example, activity data 406 relates to activity on endpoint devices 330, servers 340, and/or network devices 350. Based on activity data 406, event generator 402 generates messages 404.

Messages 404 are stored in one or more message queues 408. Message queue 408 is stored in memory 410. Message broker 412 provides messages (e.g., 404) from message queue(s) 408 to one or more computing devices that provide services 414.

In one embodiment, each event generator(s) 402 is a component or service that generates and emits events or notifications based on various activities, triggers, or conditions occurring within a cloud system. These events could include actions like resource provisioning, service status changes, errors, user interactions, or data updates. In one example, event generators 402 enable real-time monitoring, logging, and automation. They allow other services, applications, or external systems to react and respond accordingly to the events they emit, facilitating dynamic and responsive cloud infrastructure.

In one embodiment, event generator(s) 402 triggers events in response to activities that occur in associated computing systems. Each event generator can be associated with a message broker channel. When a system event occurs, the event generator publishes information about the event through the relevant message broker channel. Channel rules can be configured for each event generator.

In one example, an event generator gathers information by monitoring a task or a statistic or by probing a server for access or connectivity. The event generator has a specified threshold or condition, which, when met, causes an event to be created (e.g., generate a message 404). The event is passed to an event monitor task, which checks whether an associated event handler has been defined. If an event handler has not been defined, the event monitor task does nothing. If an event handler has been defined, the event monitor carries out the instructions in the event handler.

In one embodiment, rate limiter 416 sets rate limits for one or more of services 414. In one example, rate limiter 416 uses a dynamic rate limiter such as described above. In one example, the dynamic rate limiter resets rate limits previously established by a static rate limiter coupled to control access by services 414 to servers 422. In one example, servers 422 include servers 150, data center 156, clouds 152, 154, and/or remote computing devices 240. In one embodiment, updated rate limits established by rate limiter 416 are stored in data store 424.

Rate limiter 416 sets rate limits based on monitoring data 420. In one example, monitoring data 420 includes data regarding context 211 and/or metrics 320.

In one embodiment, monitoring data 420 is provided as an input to neural network 426. An output from neural network 426 can be included in monitoring data 420 used by rate limiter 416.

In one example, monitoring data 420 relates to a context of computing resources 418. In one example, the context is data regarding health or performance metrics. In one example, computing resources 418 includes resources that are upstream to services 414, and/or downstream from services 414. In one example, computing resources 418 includes dependent upstream application services used as an input to services 414, and/or dependent downstream application services that use an output from services 414.

In one example, computing resources 418 includes servers 340 and/or computing devices that provide services 103, 203. In one example, computing resources 418 includes remote computing devices 240. In one example, computing resources 418 includes network devices 230, 350. In one example, computing resources 418 includes endpoint devices 110, 112.

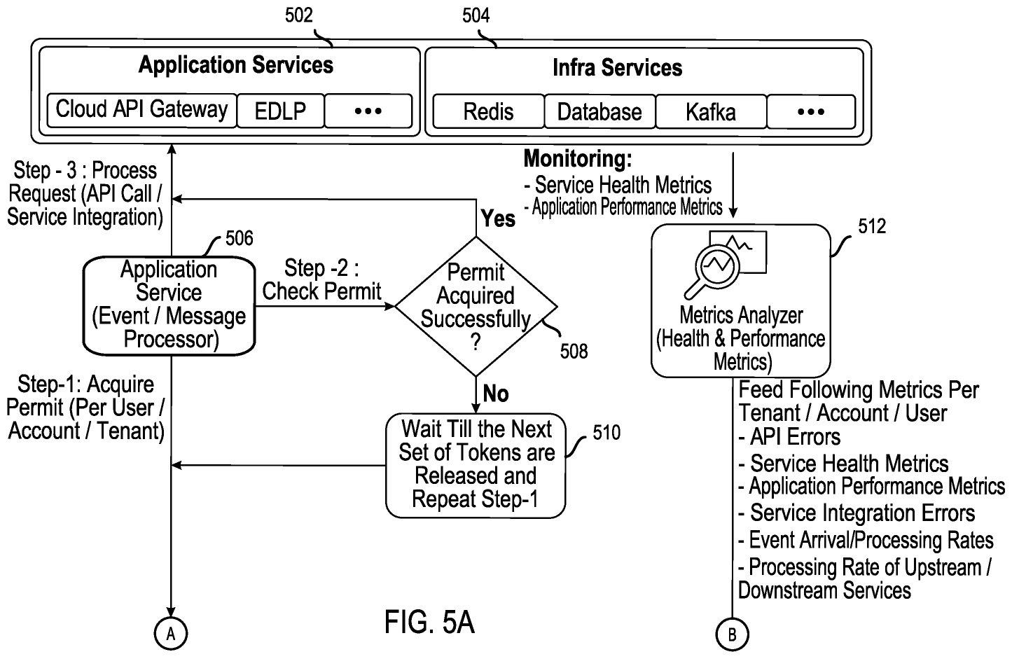

FIGS. 5A and 5B show a rate limiter that controls rate limits for application services based on monitoring of health and performance metrics, in accordance with some embodiments. Application service 506 is an example of various application services that are rate-controlled. In one example, application services 502 include a cloud API gateway and/or enterprise data loss prevention (EDLP). Application services 502, 506 can depend on infrastructure services 504. In one example, infrastructure services 504 includes a database and/or a distributed caching service.

In one embodiment, an application service is implemented in a micro services architecture. In one example, the application service is a listener that listens to messages on a queue. In one example, the application services generally are micro services that process requests, messages, or events.

In one embodiment, a workflow associated with an application service can depend on upstream or downstream services. A rate limit for the application service is dynamically adjusted by a rate limiter 538 based on a context of the upstream and/or downstream services. In one example, the upstream or downstream services can be internal (e.g., on an internal network of an enterprise) and/or external (e.g., services accessed in a public cloud through a gateway using an external network).

In one example, application service 506 has a dependency with an API server. The API server can be internal to an enterprise gateway or external to the gateway. In one example, dependent services of application service 506 include both API services and infrastructure services.

In one example, the application services, dependent services, static rate limiter 536, dynamic rate limiter 538, and/or metrics analyzer 512 run on virtual servers in a cloud computing environment.

In one embodiment, a rate limiter is implemented using dynamic rate limiter 538 and static rate limiter 536. Static rate limiter 536 is, for example, a token bucket implementation. In one example, initial rate limits 534 are stored in memory and used to initialize an instance of static rate limiter 536. In one example, the initial rate limits are stored in configuration database 530.

Dynamic rate limiter 538 resets rate limits based on monitoring metrics using metrics analyzer 512. The reset rate limit is applied to static rate limiter 536. In one example, an updated rate limit is applied to an instance of static rate limiter 536 for each of multiple users, tenants, or accounts.

In one example, the reset rate limits are stored in data store 532. In one example, dynamic rate limiter 538 uses a machine learning component to evaluate context and generate updated rate limits.

During operation, application service 506 acquires permits from static rate limiter 536. The permits allow application service 506 to operate at a rate as controlled by the most recent rate limit established by dynamic rate limiter 538. In one example, the rate at which permits are required determines a number of API calls that can be made by application service 506 to a remote server.

If the permit is acquired successfully, then application service 506 is allowed to make a process request to another computing device (e.g., remote computing device 240). If the permit is not acquired successfully, then application service 506 waits until additional tokens are released by static rate limiter 536.

Metrics analyzer 512 analyzes health and performance metrics for computing resources. In one example, the computing resources are computing resources 418. In one example, the computing resources are servers used to provide dependent services of application service 506. In one example, metrics analyzer 512 receives metrics data from one or more monitoring services. In one example, the metrics include one or more of the following: processing rates for upstream or downstream services; event arrival or processing rates, service integration errors, application performance metrics, service health metrics, and/or API errors.

In one embodiment, the metrics are analyzed for each tenant, account, or user. The rate limiter adjust rate limits using the respective metrics analysis for that tenant, account, or user.

In one example, a static rate limiter uses a token bucket type implementation and provides a fixed number of tokens per minute per category. Before making an API call, an application service gets a token. If the token not received, then no call is made.

A dynamic rate limiter intelligently understands the computing environment, and increases or decreases the number of tokens per minute based on this understanding. For example, if there is a server error situation detected, the dynamic rate limiter is programmed to understand that there is an error situation, and in response to reduce the number of tokens per minute, then intelligently increase the number of tokens per minute when the server recovers from the error(s). In contrast, prior static rate limiters continue at a same rate regardless of the error or other situation.

In one embodiment, one tenant has a higher priority than another tenant (e.g., a high priority account versus a low priority account). The bandwidth available for each tenant is adjusted according to the priority of the tenant. Static rate limits alone cannot account for any spare bandwidth that may exist from time to time. However, in some cases, a high priority account is not using its full bandwidth. Thus, another account can temporarily use a portion of that available bandwidth. In some cases, spare bandwidth can be preferentially allocated to high-priority tenants.

In one embodiment, application service 506 is used in an event/message driven architecture. Application service 506 is responsible for servicing requests that are in a queue (e.g., message queue 408). In one example, application service 506 processes events that are fetched from external servers/systems accessed in a cloud using the cloud API gateway (e.g., public clouds such as Office 365, etc.). Application service 506 gathers events of interest from one or more clouds and puts them in a local message broker.

In one embodiment, application service 506 reads messages from a message broker and processes the messages one by one. There can be multiple instances of application service 506 running. Events and messages to be processed by the application service can come from external services and/or internal processes. The application service is integrating with other application services external and/or internal.

In one embodiment, a rate limiter instance is created/initialized for each tenant/user. Application service 506 is responsible for initializing a rate limiter instance if it does not exist for a given tenant/user. The rate limiter instance distributes the tokens.

In one example, each acquired permit is for making one API call. A permit is given only if within the rate limits for the tenant.

In one example, a dynamic rate limiter is a process that controls a static rate limiter. Each static rate limiter instance is capable of issuing tokens. Each instance is for a given user. Each instance has a predefined rate limit configured at creation of the instance. The limit applies to issuance of permits for any application service. For example, no more than 30 permits are issued per minute. The dynamic rate limiter reinitializes the static rate limiter instances with a new value based on monitoring metrics.

In one embodiment, monitoring metrics are based on monitoring communications that may arrive from many sources. The communications are not limited to coming in through the cloud API gateway. In one example, a security service having deployed endpoint devices and/or network devices is integrated with a monitoring solution that is a source of metrics for feedback monitoring. In one example, the metrics are monitored to detect any failures or any delays in processing. Monitoring data can generally come from any internal or external process.

In one embodiment, the dynamic rate limiter configures the static rate limits. The dynamic rate limiter, when it is initialized, will read the rate limits and set the rate limits for all users. A data store can be used if it is desired to configure a different default rate limit for a user at runtime.

In one example, a message broker (not shown) is the source of all events or messages for application service 506. For example, events or messages come from internal services, and/or from external services through the cloud API gateway. When processing a message, application service 506 acquires a permit. Application service 506 may need to make one or more API calls to process the message. Application service 506 may also need to interact with an internal database and/or other resources to process the message.

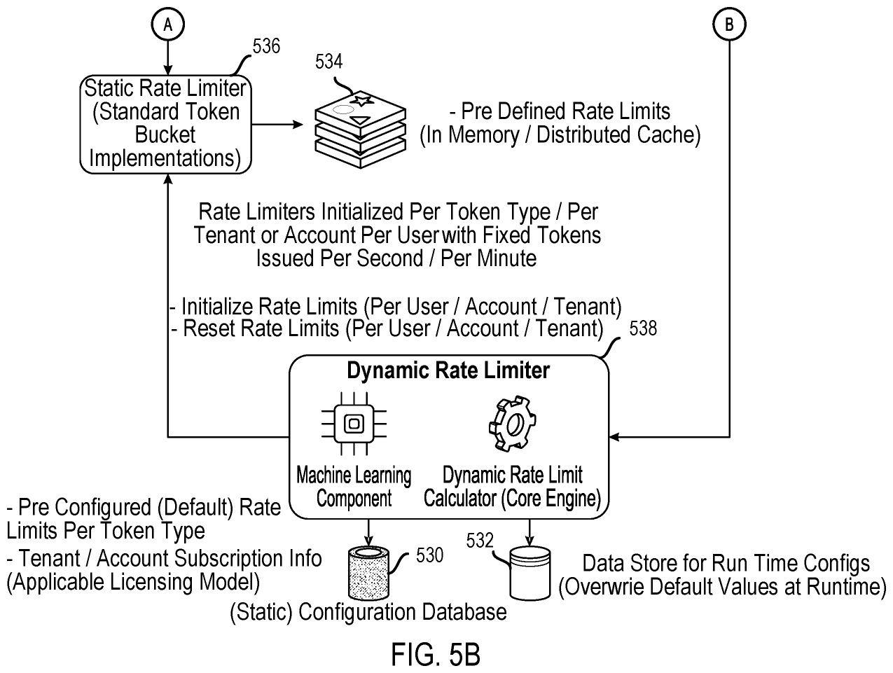

FIG. 6 shows a rate limiter that controls rate limits for access to remote and/or other servers by event processors 610, 614 based on output from a metrics analyzer 622, in accordance with some embodiments. In one embodiment, the rate limiter is implemented as a dynamic rate limiter 602 at controls rate limits of a static rate limiter 604. For example, dynamic rate limiter 602 initializes rate limits when an instance of static rate limiter 604 is launched for a user or tenant (e.g., as requested by an application service). Dynamic rate limiter 602 resets the rate limits based on evaluation of metrics (e.g., context 211, metrics 320) by metrics analyzer 622. In one example, metrics analyzer 622 is similar to metrics analyzer 512.

Event generator 606 generates events and/or messages based on activity in a computing environment. In one embodiment, the activity is user activity on endpoint devices 110, 112, and/or activity on network devices 230, 350. In one example, event generator 606 is similar to event generator 402.

In one embodiment, event generator 606 generates user activity messages based on user activity in a cloud computing environment. The messages are stored in message queue 608. Event processor 610 processes messages from message queue 608. After processing by event processor 610, the messages proceed to message queue 612. Event processor 614 processes messages from message queue 612. After the message is fully processed (e.g., Stages 1 and 2 are completed) for its corresponding workflow, event logging 616 is used to record data associated with processing of the message.

During processing of messages, each event processor 610, 614 accesses various servers. In one example, this access includes accessing application services 618 and/or infrastructure services 620. In one example, this access includes accessing remote computing devices 240. In one embodiment, each event processor 610, 614 is an application service (e.g., 506).

Prior to accessing one or more servers, each event processor 610, 614 acquires a token from static rate limiter 604. In one embodiment, event generator 606 acquires a token from static rate limiter 604 when generating events and/or messages. In one embodiment, processing failures of application services are reduced by using a dynamic rate limiter. Services deployed in a micro services architecture implementation or an event driven architecture implementation often process messages posted (asynchronously) by other services. Processing of messages may involve making API calls to a third-party service like an API Gateway of a SaaS Cloud. The processing rate of messages is constrained by API rate limits enforced by the third-party service and the health of other dependent application services like data loss prevention (DLP) or infrastructure services like Nginx, Redis, etc.

API based CASB (cloud access security broker) solutions typically have a message driven architecture implementation where events/messages are generated for user activity on SaaS and/or IaaS clouds. User activity on the cloud is captured as messages, and these messages are processed in multiple stages (e.g., event processors 610, 614) for threat assessment and remediation (e.g., risk assessment for endpoint devices and/or network devices such as described above). In one example, the CASB solution is a cloud-based security solution placed between cloud consumers and cloud service providers (e.g., AWS, GCP, Azure, Office365, gdrive) to interject and examine data movement based on security policies (e.g., 322).

These event/message processing services can be integrated with a dynamic rate limiter to avoid dropping messages during any temporary outage of dependent service(s). Instead of dropping messages after a fixed number of attempts of fail/retry, processing rate(s) are adjusted to reduce or avoid failures during any temporary outage of dependent services. These messages can be processed successfully once the health of dependent application/infrastructure services is restored.

In one example, the dynamic rate limiter continuously adjusts client-side rate limits (e.g., per tenant/per account/per user) based on analysis of monitoring metrics that indicate the health or other characteristics of dependent application and/or infrastructure services.

In one embodiment, event generator 606 is an application service. Event generator 606 gathers user activity of one or more clouds in the form of messages. Each message can be processed in one or more stages (e.g., as part of a workflow system). Once the first stage of processing is complete, a message is pushed to another message broker for processing by a second application service (e.g., at Stage 2). Event logging is typically done after service(s) is complete. Event logging is done at the end of the message lifecycle for audit purposes.

In one embodiment, a rate limiter instance for a user is shared by all application services for that user. The rate limit is a common limit across all the services for the user.

In one example, rate limiter instances are made to indicate how many API calls can be made by application services per user/account/tenant. In one example, a rate limiter instance determines how many tokens have issued for a particular user across all services of the user.

In one example, a dynamic rate limiter re-initializes a static rate limiter instance with the new value of a rate limit. The reset rate limits are the dynamically calculated limits. The initialized rate limit is a pre-configured rate limit.

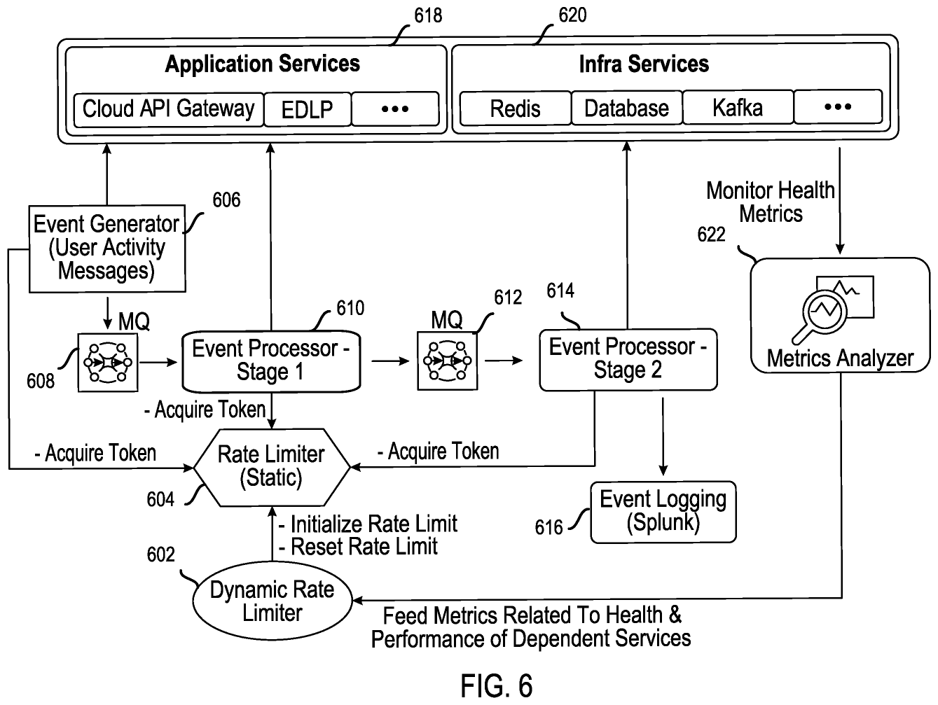

FIG. 7 shows a rate limiter that controls rate limits for regular events and overflow events based on monitoring metrics, in accordance with some embodiments. In one embodiment, the rate limiter is implemented using dynamic rate limiter 702, which initializes and resets rate limits for static rate limiter 704. In one example, dynamic rate limiter 702 operates similarly to dynamic rate limiter 602.

In one embodiment, dynamic rate limiter 702 controls rate limits based on output from metrics analyzer 716. In one example, metrics analyzer 716 monitors health metrics and/or processing rates for each tenant or user. In one example, metrics analyzer 716 provides feed metrics to dynamic rate limiter 702. For example, the feed metrics are related to health and performance of dependent services associated with application services and/or event processors. In one example, metrics analyzer 716 provides feed metrics related to message arrival and/or message processing rates at the tenant, account, or user level.

In one embodiment, metrics analyzer 716 uses input data from monitoring services. In one example, the monitoring services provide input regarding a context of computing resources 418. In one example, the context relates to an extent of usage of computing resources 418. In one example, the context relates to an available bandwidth for computing resources 418.

Event generator 708 generates events associated with one or more computing devices. In one example, event generator 708 is similar to event generator 402 or 606. In one embodiment, the events relate to user activity. In one example, the user activity relates to security risk evaluation for computing devices of tenants and/or users. In one example, the computing devices include endpoint devices for users of an enterprise. In one example, the events relate to cloud activity for a tenant. In one example, event generator 708 generates user activity messages.

In one embodiment, messages generated by event generator 708 are stored in message queue 710 or 714 based on an arrival rate (e.g., and/or another threshold) for events. If events arrive below a pre-configured arrival rate (e.g., regular events) for a particular tenant, account, or user, then messages are stored in message queue 714. If events arrive above the pre-configured arrival rate (e.g., overflow events), then messages are stored in message queue 710.

Event processor 706 processes events based on messages from message queue 714 (e.g., provided by a message broker). Event processor 712 processes events based on messages from message queue 710 (e.g., provided by a message broker). Each event processor 706, 712 requires tokens from static rate limiter 704 for access requests to other computing devices (e.g., API calls). The rate that tokens can be acquired is subject to the rate limit(s) for the tenant/account/user corresponding to the event(s) being processed.

Event processors 706, 712 access other computing devices when processing events. In one example, each event processor accesses application services 718 using a cloud API gateway. In one example, each event processor accesses infrastructure services 720. Such accesses require obtaining a token from static rate limiter 704.

In one embodiment, event generator 708 accesses one or more computing devices using a cloud API gateway. In one example, the computing devices are servers in a public cloud (e.g., Amazon Web Services (AWS)). In one example, data received from the servers relates to user activity. In one example, data received from the servers is used for assessing security risk. In one example, event generator 708 communicates with or receives data from endpoint devices and/or network devices of a tenant or user.

In one embodiment, the processing rate for overflow events is dynamically adjusted. For example, when implementing solutions using message driven architectures (e.g., CASB implementations), overflow events can occur. For example, the overflow events may be due to an event burst for a specific tenant/account/user. In such scenarios, events of the specific tenant/account/user arriving at more than a pre-configured static arrival rate are pushed to overflow queues (e.g., specific to the tenant/account/user). The overflow events are then processed at a lower processing rate.

Prior approaches that use only a static rate limiter are not able to fully utilize available computing resources. For example, if the event burst is momentary, the overflow events cannot be processed using spare bandwidth available for the respective tenant/account/user when the event arrival rate returns to a normal rate or below (e.g., below the pre-configured arrival rate). Instead, overflow events continue to be processed at a lower processing rate. This does not fully utilize the spare capacity that may be available at a later time (e.g., after the event burst) for the respective tenant/account/user (e.g., during off-peak hours).

The problem above is addressed by a dynamic rate limiter (e.g., 702) that monitors the processing rate of events for a specific tenant/account/user to dynamically adjust the processing rate of overflow events to take advantage of the spare bandwidth available for processing events of the respective tenant/account/user. In one example, dynamic rate limiter 702 adjusts a rate limit associated with event processor 712 based on evaluation of spare bandwidth.

By using a dynamic rate limiter, the processing rate of overflow events can be increased. In one example, the processing rate is increased by using available computing resources 418. In one example, the available computing resources include dependent services (e.g., SaaS/IaaS accessed by a cloud API gateway).

In one embodiment, the dynamic rate limiter ensures that a particular tenant/account/user is not unnecessarily subjected to a lower processing rate for overflow events (e.g., generated during a previous peak period). During later periods when there is normal or below normal event arrival rate for the respective tenant/account/user, the processing rate of overflow events is adjusted to consume spare bandwidth available for processing events of the respective tenant/account/user. This dynamic adjustment of rate limits for overflow events enables an increase in the rate of message processing (e.g., so that policy (e.g., policies 322) enforcement is not delayed).

In one embodiment, dynamic rate limiter 702 continuously adjusts client-side rate limits per tenant/per account/per user for processing overflow events based on analysis of current event arrival rate(s) and event processing rate(s) per tenant/account/user. This takes advantage of spare bandwidth available for the respective tenant/account/user. By use of a dynamic rate limiter, the processing rate of overflow events can increase or decrease depending on a backlog of regular events and available cloud API limits. This improves the utilization of available processing capacity.

In one example, a processing rate of overflow events (e.g., as required by a service level agreement) may require processing messages within a fixed time period (e.g., 15 minutes) of a message being received. In many cases, an incoming rate of messages varies widely. As an example, there can be a flood of messages from a particular user.

In one example, the service level agreement to process messages within a fixed time period may require that messages are limited to an incoming rate (e.g., 1,000 messages per minute). Messages received that exceed the incoming rate are processed based on available bandwidth (e.g., using dedicated offload bandwidth that is different from regular bandwidth). However, spare bandwidth can exist when other tenants/users are not using their full allocation of bandwidth. By using dynamic rate limiter 702, this spare bandwidth can be used for processing overflow events.

In one example, event generator 708 pushes all events to be processed by a downstream service (e.g., 706 or 712). Overflow events are pushed to an overflow message broker queue 710. Regular events are processed using bandwidth dedicated to a user or tenant. The overflow events are not guaranteed handling at any particular processing rate. In one example, 90% of user/tenant bandwidth is dedicated to regular events, and 10% is dedicated to overflow events. Dynamic rate limiter 702 is used to increase a processing rate of overflow events by event processor 712 when spare bandwidth is available.

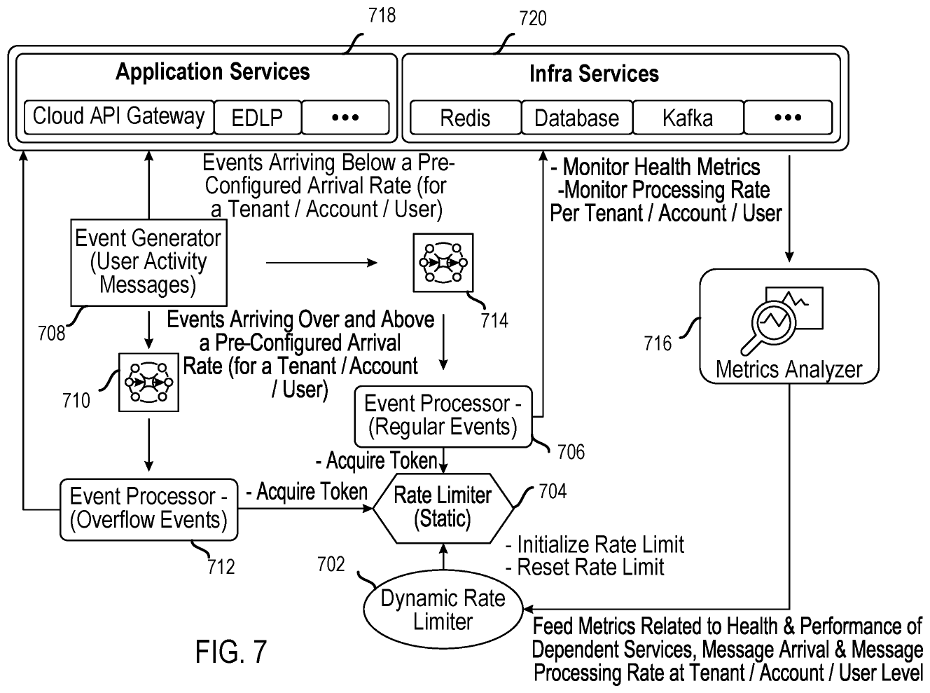

FIG. 8 shows a method for dynamically updating rate(s) at which application service(s) are permitted to access one or more servers, in accordance with some embodiments. For example, the method of FIG. 8 can be implemented in the systems of FIGS. 1-7.

The method of FIG. 8 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 8 is performed at least in part by one or more processing devices (e.g., 208).

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 801, one or more servers are accessed by one or more application services. In one example, the servers are located in public cloud 152 and/or private cloud 154. In one example, servers 150 are accessed by services 103. In one example, servers in data center 156 are accessed by services 103.

At block 803, one or more rates at which the application services access the one or more servers are controlled. In one example, access rates for services 103 are controlled by rate limiter 105.

At block 805, monitoring data is received regarding one or more networks and/or computing devices. In one example, monitoring data 420 is received. In one example, the received monitoring data indicates health or performance characteristics associated with computing resources 418. In one example, monitoring data 420 indicates an availability of spare bandwidth.

At block 807, the monitoring data is evaluated. In one example, the monitoring data is evaluated by metrics analyzer 512.

At block 809, the one or more rates at which application services access the one or more servers is dynamically updated. This update is based on evaluation of the monitoring data. In one example, dynamic rate limiter 538 resets a rate limit for a user, account, or tenant based on output from metrics analyzer 512.

In one embodiment, a system comprises: a gateway (e.g., cloud API gateway) (e.g., 102) configured to provide network access to at least one server (e.g., external cloud servers) (e.g., 150); and at least one computing device configured to: execute at least one service (e.g., 103) (e.g., an application service) that accesses the server via the gateway; control (e.g., using rate limiter 105) at least one rate at which the service accesses the server; monitor a context (e.g., 211) associated with the service; and dynamically update the rate at which the service accesses the server to reflect any changes to the monitored context (e.g., updates are made in real-time such as, for example, less than 1-3 seconds after a change in context is determined by a server running a process to monitor network status codes).

In one embodiment, the service accesses the server using at least one network (e.g., 120, 140), and monitoring the context comprises receiving data regarding activity associated with network communication (e.g., metrics regarding internal and/or external networks used by the service to access an Amazon Web Services (AWS) cloud server) (e.g., monitoring data including network status codes) (e.g., context includes HTTP status codes and/or network error codes).

In one embodiment, the service is an application service (e.g., service 414) that uses at least one input from at least one dependent service (e.g., internal and/or external service) (e.g., an upstream or downstream service), or provides at least one output to the dependent service; and monitoring the context comprises receiving data (e.g., health and/or performance metrics) regarding the dependent service.

In one embodiment, the service is an application service that receives communications for processing.

In one embodiment, the communications comprise at least one of: a communication regarding an event; a message (e.g., a message from message queue 408); or a request.

In one embodiment, the system further comprises a message broker (e.g., 412) that queues messages for processing by the application service, wherein processing the messages includes making calls to the server via the gateway.

In one embodiment, the system further comprises a rate limiter (e.g., 416) (e.g., an instance of a static rate limiter used for a tenant having one or more users) configured to provide a respective token to each of a plurality of first services, wherein each token corresponds to a number of calls that the respective first service is permitted to make to the server via the gateway.

In one embodiment, the rate limiter is further configured to control a rate of providing tokens to the first services (e.g., control the rate using a dynamic rate limiter) (e.g., real-time control of the rate based on detected changes in network status and/or receiving error codes from network devices).

In one embodiment, wherein: updating the rate at which the service accesses the server comprises determining new rates based on the monitored context (e.g., based on monitoring data 420); the rate limiter is further configured to instantiate multiple new instances of a static rate limiter (e.g., static rate limiter 536) per tenant, per user, or per account; and each of the new instances is configured using one of the new rates.

In one embodiment, a method comprises: accessing at least one server by a plurality of application services, wherein the application services are executing on at least one computing device and access the server through at least one gateway; controlling at least one rate at which the application services access the server; receiving monitoring data regarding at least one network or computing device (e.g., health or performance metrics for internal and/or external networks or servers); evaluating the monitoring data; and dynamically updating the at least one rate at which the application services access the server based on evaluating the monitoring data (e.g., by using a dynamic rate process to reset the respective rate limit for one or more instances of a static rate limiter to reflect a change in context determined from metrics monitoring).

In one embodiment, evaluating the monitoring data comprises providing a result from a machine learning model (e.g., artificial neural network 426) that uses the received monitoring data as an input.

In one embodiment, the monitoring data (e.g., data collected by metrics analyzer 512) includes data indicating an error associated with a service that is upstream or downstream to one or more of the application services (e.g., an error response from a cloud server or API gateway device).

In one embodiment, the method further comprises: determining that first events received by a first application service exceed an arrival rate threshold; and in response to determining that the first events exceed the arrival rate threshold, moving the first events to an overflow queue (e.g., message queue 710).

In one embodiment, the method further comprises: identifying spare bandwidth in computing resources used to provide services to a first tenant or user (e.g., spare bandwidth can be an unused portion of a bandwidth allocation for the first tenant and/or for a different tenant); and in response to identifying the spare bandwidth, adjusting a rate limit for processing the first events in the overflow queue (e.g., increase the rate limit for overflow events to use the spare bandwidth).

In one embodiment, identifying the spare bandwidth comprises analyzing a current event arrival rate for the first tenant or user, and an event processing rate for the first tenant or user.

In one embodiment, a system comprises: an event generator (e.g., 402, 606, 708) configured to gather data regarding user activity and generate messages based on the gathered data; memory configured to store the messages in a queue; a message broker configured to retrieve the messages from the queue for processing by at least one first service; and at least one processing device configured to execute a rate limiter to: monitor characteristics of computing resources (e.g., services that are upstream or downstream to the first service); and control, based on the monitored characteristics, at least one rate limit for the first service.

In one embodiment, the system further comprises a data store (e.g., a database) configured to store a respective rate limit configuration for each of a plurality of tenants or users.

In one embodiment, the rate limit defines a maximum number of application programming interface (API) calls to a server that can be made by the first service.

In one embodiment, monitoring the characteristics includes analyzing event arrival or message processing rates for each of a plurality of tenants or users.

In one embodiment, monitoring the characteristics further includes monitoring operating or performance metrics for the event generator.

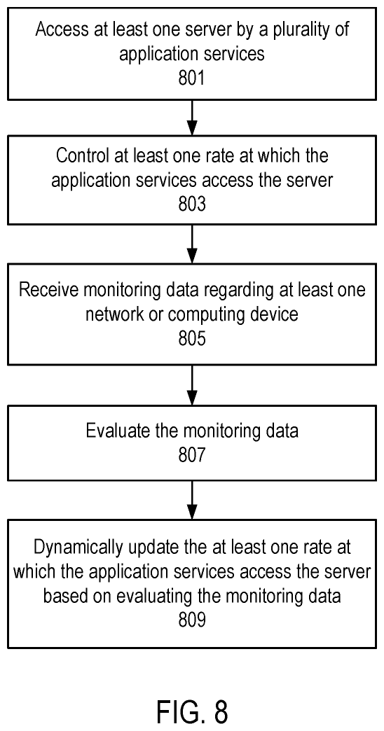

FIG. 9 shows a block diagram 901 of a computing device (e.g., a server running rate limiter 416) (e.g., a server providing services 414) (e.g., a gateway, a network device, a monitoring server, or mobile device management (MDM) server) which can be used in various embodiments. While FIG. 9 illustrates various components, it is not intended to represent any particular architecture or manner of interconnecting the components. Other systems that have fewer or more components may also be used. In an embodiment, a monitoring server, an administrator server, an authenticity server, or an identity provider may each reside on separate computing systems, or one or more may run on the same computing device, in various combinations.

In FIG. 9, computing device 901 includes an inter-connect 902 (e.g., bus and system core logic), which interconnects a microprocessor(s) 903 and memory 908. The microprocessor 903 is coupled to cache memory 904 in the example of FIG. 9.

The inter-connect 902 interconnects the microprocessor(s) 903 and the memory 908 together and also interconnects them to a display controller and display device 907 and to peripheral devices such as input/output (I/O) devices 905 through an input/output controller(s) 906. Typical I/O devices include, for example, mice, keyboards, modems, network interfaces, printers, scanners, and/or video cameras.

The inter-connect 902 may include one or more buses connected to one another through various bridges, controllers and/or adapters. In one embodiment the I/O controller 906 includes a USB (Universal Serial Bus) adapter for controlling USB peripherals, and/or an IEEE-1394 bus adapter for controlling IEEE-1394 peripherals.

The memory 908 may include ROM (Read Only Memory), and volatile RAM (Random Access Memory) and non-volatile memory, such as hard drive, flash memory, etc.

Volatile RAM is typically implemented as dynamic RAM (DRAM) which requires power continually to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random-access memory.

The non-volatile memory can be a local device coupled directly to the rest of the components in the computing device. A non-volatile memory that is remote from the computing device, such as a network storage device coupled to the computing device through a network interface such as a modem or Ethernet interface, can also be used.

In one embodiment, a computing device as illustrated in FIG. 9 is used to implement one or more servers that provide a gateway, monitoring service, and/or dynamic rate limiter.

In another embodiment, a computing device as illustrated in FIG. 9 is used to implement a user terminal or a mobile device on which application software and/or an endpoint agent is installed. A user terminal may be in the form, for example, of a notebook computer or a personal desktop computer.

In some embodiments, one or more servers can be replaced with the service of a peer-to-peer network of a plurality of data processing systems, or a network of distributed computing systems. The peer-to-peer network, or a distributed computing system, can be collectively viewed as a computing device.

Embodiments of the disclosure can be implemented via the microprocessor(s) 903 and/or the memory 908. For example, the functionalities described can be partially implemented via hardware logic in the microprocessor(s) 903 and partially using the instructions stored in the memory 908. Some embodiments are implemented using the microprocessor(s) 903 without additional instructions stored in the memory 908. Some embodiments are implemented using the instructions stored in the memory 908 for execution by one or more general purpose microprocessor(s) 903. Thus, the disclosure is not limited to a specific configuration of hardware and/or software.

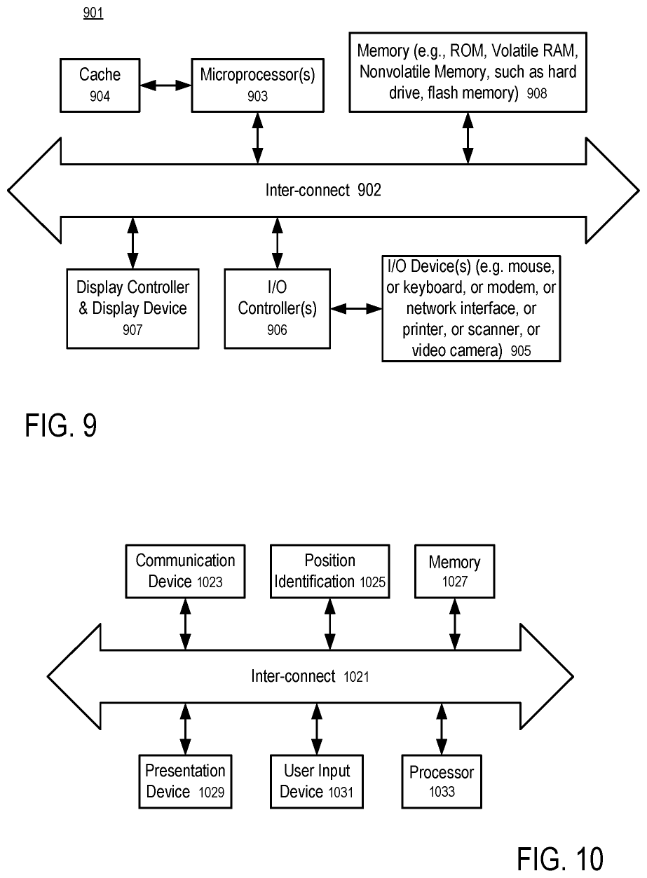

FIG. 10 shows a block diagram of a computing device (e.g., an endpoint device, a mobile device of a user, or a user terminal), according to one embodiment. In FIG. 10, the computing device includes an inter-connect 1021 connecting the presentation device 1029, user input device 1031, a processor 1033, a memory 1027, a position identification unit 1025 and a communication device 1023.

In FIG. 10, the position identification unit 1025 is used to identify a geographic location. The position identification unit 1025 may include a satellite positioning system receiver, such as a Global Positioning System (GPS) receiver, to automatically identify the current position of the computing device.

In one embodiment, data regarding the geographic location may be part of the metadata gathered by the gateway, and/or part of monitoring data used to control a rate limiter.

In FIG. 10, the communication device 1023 is configured to communicate with a server to provide data, including application data (e.g., an application identifier and a source identifier for an application being downloaded). In one embodiment, the user input device 1031 is configured to receive or generate user data or content. The user input device 1031 may include a text input device, a still image camera, a video camera, and/or a sound recorder, etc.

The disclosure includes various devices which perform the methods and implement the systems described above, including data processing systems which perform these methods, and computer-readable media containing instructions which when executed on data processing systems cause the systems to perform these methods.

The description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and such references mean at least one.

As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In this description, various functions and/or operations may be described as being performed by or caused by software code to simplify description. However, those skilled in the art will recognize what is meant by such expressions is that the functions and/or operations result from execution of the code by one or more processing devices, such as a microprocessor, Application-Specific Integrated Circuit (ASIC), graphics processor, and/or a Field-Programmable Gate Array (FPGA). Alternatively, or in combination, the functions and operations can be implemented using special purpose circuitry (e.g., logic circuitry), with or without software instructions. Embodiments can be implemented using hardwired circuitry without software instructions, or in combination with software instructions. Thus, the techniques are not limited to any specific combination of hardware circuitry and software, nor to any particular source for the instructions executed by a computing device.

While some embodiments can be implemented in fully functioning computers and computer systems, various embodiments are capable of being distributed as a computing product in a variety of forms and are capable of being applied regardless of the particular type of computer-readable medium used to actually effect the distribution.

At least some aspects disclosed can be embodied, at least in part, in software. That is, the techniques may be carried out in a computing device or other system in response to its processing device, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions (sometimes referred to as computer programs). Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer-readable medium can be used to store software and data which when executed by a computing device causes the device to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a computer-readable medium in entirety at a particular instance of time.

Examples of computer-readable media include, but are not limited to, recordable and non-recordable type media such as volatile and non-volatile memory devices, read only memory (ROM), random access memory (RAM), flash memory devices, solid-state drive storage media, removable disks, magnetic disk storage media, optical storage media (e.g., Compact Disk Read-Only Memory (CD ROMs), Digital Versatile Disks (DVDs), etc.), among others. The computer-readable media may store the instructions. Other examples of computer-readable media include, but are not limited to, non-volatile embedded devices using NOR flash or NAND flash architectures. Media used in these architectures may include un-managed NAND devices and/or managed NAND devices, including, for example, eMMC, SD, CF, UFS, and SSD.

In general, a non-transitory computer-readable medium includes any mechanism that provides (e.g., stores) information in a form accessible by a computing device (e.g., a computer, mobile device, network device, personal digital assistant, manufacturing tool having a controller, any device with a set of one or more processors, etc.). A “computer-readable medium” as used herein may include a single medium or multiple media (e.g., that store one or more sets of instructions).

In various embodiments, hardwired circuitry may be used in combination with software and firmware instructions to implement the techniques. Thus, the techniques are neither limited to any specific combination of hardware circuitry and software nor to any particular source for the instructions executed by a computing device.

Various embodiments set forth herein can be implemented using a wide variety of different types of computing devices. As used herein, examples of a “computing device” include, but are not limited to, a server, a centralized computing platform, a system of multiple computing processors and/or components, a mobile device, a user terminal, a vehicle, a personal communications device, a wearable digital device, an electronic kiosk, a general purpose computer, an electronic document reader, a tablet, a laptop computer, a smartphone, a digital camera, a residential domestic appliance, a television, or a digital music player. Additional examples of computing devices include devices that are part of what is called “the internet of things” (IoT). Such “things” may have occasional interactions with their owners or administrators, who may monitor the things or modify settings on these things. In some cases, such owners or administrators play the role of users with respect to the “thing” devices. In some examples, the primary mobile device (e.g., an Apple iPhone) of a user may be an administrator server with respect to a paired “thing” device that is worn by the user (e.g., an Apple watch).

In some embodiments, the computing device can be a computer or host system, which is implemented, for example, as a desktop computer, laptop computer, network server, mobile device, or other computing device that includes a memory and a processing device. The host system can include or be coupled to a memory sub-system so that the host system can read data from or write data to the memory sub-system. The host system can be coupled to the memory sub-system via a physical host interface. In general, the host system can access multiple memory sub-systems via a same communication connection, multiple separate communication connections, and/or a combination of communication connections.

In some embodiments, the computing device is a system including one or more processing devices. Examples of the processing device can include a microcontroller, a central processing unit (CPU), special purpose logic circuitry (e.g., a field programmable gate array (FPGA), an application specific integrated circuit (ASIC), etc.), a system on a chip (SoC), or another suitable processor.

In one example, a computing device is a controller of a memory system. The controller includes a processing device and memory containing instructions executed by the processing device to control various operations of the memory system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system comprising:
a gateway configured to provide network access to at least one server; and
at least one computing device configured to:
execute at least one service that accesses the server via the gateway;
control at least one rate at which the service accesses the server;
monitor a context associated with the service; and
dynamically update the rate at which the service accesses the server to reflect any changes to the monitored context.

2. The system of claim 1, wherein the service accesses the server using at least one network, and monitoring the context comprises receiving data regarding activity associated with network communication.

3. The system of claim 1, wherein:
the service is an application service that uses at least one input from at least one dependent service, or provides at least one output to the dependent service; and
monitoring the context comprises receiving data regarding the dependent service.

4. The system of claim 1, wherein the service receives communications comprising at least one of:
a communication regarding an event;
a message; or
a request.

5. The system of claim 4, wherein the service is an application service that receives the communications for processing.

6. The system of claim 4, further comprising a message broker that queues messages for processing by the application service, wherein processing the messages includes making calls to the server via the gateway.

7. The system of claim 1, further comprising a rate limiter configured to provide a respective token to each of a plurality of first services, wherein each token corresponds to a number of calls that the respective first service is permitted to make to the server via the gateway.

8. The system of claim 7, wherein the rate limiter is further configured to control a rate of providing tokens to the first services.

9. The system of claim 8, wherein:
updating the rate at which the service accesses the server comprises determining new rates based on the monitored context;
the rate limiter is further configured to instantiate multiple new instances of a static rate limiter per tenant, per user, or per account; and
each of the new instances is configured using one of the new rates.

10. A method comprising:
accessing at least one server by a plurality of application services, wherein the application services are executing on at least one computing device and access the server through at least one gateway;
controlling at least one rate at which the application services access the server;
receiving monitoring data regarding at least one network or computing device;
evaluating the monitoring data; and
dynamically updating the at least one rate at which the application services access the server based on evaluating the monitoring data.

11. The method of claim 10, wherein evaluating the monitoring data comprises providing a result from a machine learning model that uses the received monitoring data as an input.

12. The method of claim 10, wherein the monitoring data includes data indicating an error associated with a service that is upstream or downstream to one or more of the application services.

13. The method of claim 10, further comprising:
determining that first events received by a first application service exceed an arrival rate threshold; and
in response to determining that the first events exceed the arrival rate threshold, moving the first events to an overflow queue.

14. The method of claim 13, further comprising:
identifying spare bandwidth in computing resources used to provide services to a first tenant or user; and
in response to identifying the spare bandwidth, adjusting a rate limit for processing the first events in the overflow queue.

15. The method of claim 14, wherein identifying the spare bandwidth comprises analyzing a current event arrival rate for the first tenant or user, and an event processing rate for the first tenant or user.

16. A system comprising:
an event generator configured to gather data regarding user activity and generate messages based on the gathered data;
memory configured to store the messages in a queue;
a message broker configured to retrieve the messages from the queue for processing by at least one first service; and
at least one processing device configured to execute a rate limiter to:
monitor characteristics of computing resources; and
control, based on the monitored characteristics, at least one rate limit for the first service.

17. The system of claim 16, further comprising a data store configured to store a respective rate limit configuration for each of a plurality of tenants or users.

18. The system of claim 16, wherein the rate limit defines a maximum number of application programming interface (API) calls to a server that can be made by the first service.

19. The system of claim 16, wherein monitoring the characteristics includes analyzing event arrival or message processing rates for each of a plurality of tenants or users.

20. The system of claim 16, wherein monitoring the characteristics further includes monitoring operating or performance metrics for the event generator.
